(19) United States
(12) Patent Application Publication
(10) Pub. No.: US 2023/0103509 A1
(43) Pub. Date: Apr. 6, 2023

(54) CONFOCAL MICROSCOPY SYSTEM

(71) Applicant: Lumencor, Inc., Beaverton, OR (US)

(72) Inventors: Steven M. JAFFE, Portland, OR (US); Alex JASSO, Portland, OR (US); Claudia B. JAFFE, Portland, OR (US)

(21) Appl. No.: 17/865,369

(22) Filed: Jul. 14, 2022

Related U.S. Application Data
(60) Provisional application No. 63/221,929, filed on Jul. 14, 2021.

(51) Int. Cl. G02B 21/00

(52) U.S. Cl. CPC G02B 21/0032; G02B 21/0076; G02B 21/008; G02B 21/0044

(57) ABSTRACT

A spinning-disk confocal microscopy system, and components thereof, with improved illumination. The system may include a liquid light guide (LLG), a reflecting mirror tube, and/or other light guide directing light from a light source to the system's confocal optics. An LLG may provide certain advantages over other conveyance mechanisms. For example, thermal motion of the liquid in the LLG may alter the optical path and scatter light, reducing or eliminating spatial and temporal coherence introduced by the light source. This, in turn, may create more uniform illumination on samples. A reflecting mirror tube may similarly have advantages.

### CROSS-REFERENCE TO PRIORITY APPLICATION

This application is based upon and claims the benefit under 35 U.S.C. § 119(e) of the following U.S. provisional patent applications: Ser. No. 63/221,929, filed Jul. 14, 2021; and Ser. No. 63/388,979, filed Jul. 13, 2022. Each of these applications is incorporated herein by reference in its entirety for all purposes.

### INTRODUCTION

Light microscopy comprises a spectrum of approaches that use visible (or near visible) electromagnetic radiation to produce an image of an object. Typically, the specimen is tiny (e.g., a cell), and the goal is to generate a high-magnification (500-1000×) image with excellent resolution and contrast. The different approaches are distinguished by their methods of generating contrast and/or their resolution.

Fluorescence microscopy is the dominant form of light microscopy in the biological sciences. It is sensitive, selective, and compatible with multi-color imaging of living specimens. In this approach, fluorescent specimens emit radiation (“fluoresce”), primarily in the visible, and that emitted radiation is captured to create an image. Fluorescent specimens emit (“emission”) in response to energy input (“excitation”), which (except in the case of multi-photon excitation) is supplied by higher-energy, shorter-wavelength radiation. Because the input light is spectrally distinct, it can be blocked using filters. The result is a high-contrast image showing a fluorescence signal against a dark background. Most biological samples are not intrinsically fluorescent, and thus samples must be labeled with fluorescent tags. The tags typically are designed to interact with specific constituents of interest (e.g., in cells), so signals arise only from well-defined species or structures.

There are two standard forms of fluorescence microscopy. The most basic form, termed “widefield” microscopy, generally illuminates all positions and all depths of the sample simultaneously. Unfortunately, this can lead to blurring, especially with thick samples, because the image will includes contributions from above and below the image plane. An alternative form, termed “confocal” microscopy, generates images with markedly reduced blur by scanning the sample with a focused illumination spot and then rejecting out-of-focus fluorescence using a pinhole filter located in a conjugate image plane. Laser scanning confocal microscopy (LSCM) uses a single illumination spot and a single pinhole. It is very effective at reducing blur. However, it is also very slow, making it poorly suited for imaging of live samples. Spinning disk confocal microscopy (SDCM) overcomes the speed limitation, allowing imaging of live samples, by simultaneously using many spots and many pinholes. However, spreading the excitation light over many spots means that the excitation light can be less intense, reducing fluorescence and slowing imaging. Thus, there is a need for confocal microscopy systems, particularly spinning disk systems, with enhanced illumination capabilities.

### Summary

The present disclosure provides a spinning-disk confocal microscopy system, and components thereof, with improved illumination. The system may include a liquid light guide (LLG), a reflecting mirror tube, and/or other light guide directing light from a light source to the system's confocal optics. An LLG may provide certain advantages over other conveyance mechanisms. For example, thermal motion of the liquid in the LLG may alter the optical path and scatter light, reducing or eliminating spatial and temporal coherence introduced by the light source. This, in turn, may create more uniform illumination on samples. A reflecting mirror tube may similarly have advantages.

### BRIEF DESCRIPTION OF THE DRAWINGS

FIG. 1 is a very high level schematic view of a confocal microscopy system, in accordance with aspects of the present disclosure.

FIG. 2 is a more detailed view of aspects of a confocal microscopy system, such as the system of FIG. 1, emphasizing the confocal optics.

FIG. 3 is a partially schematic side view of an exemplary liquid light guide, coupled left and right to a light engine and confocal optics, respectively, in accordance with aspects of the present disclosure.

FIG. 4 shows three views of a reflecting mirror tube, in accordance with aspects of the present disclosure.

### DETAILED DESCRIPTION

The present disclosure provides a spinning-disk confocal microscopy system, and components thereof, with improved illumination. The system may include a liquid light guide (LLG), a reflecting mirror tube, and/or other light guide directing light from a light source to the system's confocal optics. An LLG may provide certain advantages over other conveyance mechanisms. For example, thermal motion of the liquid in the LLG may alter the optical path and scatter light, reducing or eliminating spatial and temporal coherence introduced by the light source. This, in turn, may create more uniform illumination on samples, such that intensity variations in images captured by the system are more likely to reflect variations in the sample than uninteresting and unwanted variations in the illumination. The reflecting mirror tube may similarly have advantages.

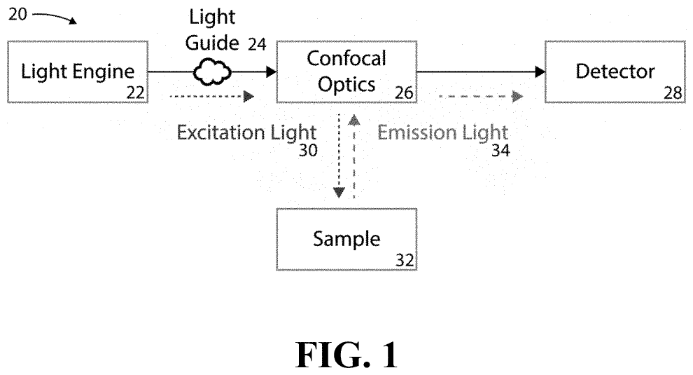

FIG. 1 shows an exemplary confocal microscopy system 20, in accordance with aspects of the present disclosure. The system may include a light engine 22, a light guide 24, confocal optics 26, and a detector 28. The light engine may be configured to produce fluorescence excitation light 30. The light guide, which may comprise an LLG and/or a reflecting mirror tube, may be configured to transmit fluorescence excitation light output from the light engine to the confocal optics. The confocal optics may be configured to direct the fluorescence excitation light onto a sample 32 and to collect fluorescence emission light 34 emitted by the sample. In particular, in spinning disk embodiments, the confocal optics may simultaneously illuminate and collect light from at least two discrete positions (“spots”) in the sample separated by an unilluminated region. Finally, the detector may be configured to capture fluorescence emission light from the sample to form an image of the sample.

Light Engine. The light engine is used to generate fluorescence excitation light capable of exciting fluorescence from the sample. It may include one or more individual light sources (e.g., one, two, three, four, five, six, seven, eight, nine, or more sources). The light sources may include lasers, light pipes, and/or light-emitting diodes (LEDs), among others. Each light source may be capable of emitting at one or more predominantly single wavelengths (e.g., 488 nm or 514 nm) or over one or more ranges of wavelengths (e.g., 450 nm to 550 nm). In some cases, two or more light sources may output light having the same spectral qualities, where the light from the two or more sources is combined to increase its intensity. The intensity of light from each light source may be independently adjustable, for example, from 0% to 100% relative intensity. Light output by the light engine may come from a single source or be a blend of light from two or more sources. The spectral properties of light output by the light engine may be matched to its intended use, for example, to excite fluorescence from preselected fluorescent tags. The light engine may optionally include a diffuser or despeckler for reducing laser speckle and/or other inhomogeneities. Exemplary light engines may include, among others, the Lumencor CELESTA Light Engine. See U.S. Provisional Patent Application Ser. No. 63/388,979, filed Jul. 13, 2022, for more details (particularly Appendices A1 and A2).

Light Guide. The light guide is used to direct light from the light engine to the confocal optics. It most generally comprises any mechanism other than a fiber optic for coupling light from the light engine to the confocal optics. Exemplary embodiments may include an LLG and/or a reflecting mirror tube, among others. See U.S. Provisional Patent Application Ser. No. 63/388,979, filed Jul. 13, 2022, for more details (particularly Appendix B). Both embodiments provide advantages relative to fiber optics. For example, liquid light guides may be cheaper, less subject to breakage, and/or less likely to transmit or create laser speckle, among others. In addition, light guides may be larger than common fibers, making it easier to couple light into and/or out of them. Suitable lenses, such as those shown in the '979 application, and discussed further below, may be used to prepare light for entry into the light guide and/or to prepare light exiting the light guide for entry into the confocal optics. These lenses may be integrated into the light engine and confocal optics, respectively, and/or onto ends of the light guide.

Particular attention is required to the design of the light engine and optics in order to match the instrument etendue. A confocal scanner can have a very small etendue and will simultaneously require relatively high brightness levels. Therefore, it generally is important that the etendue of the light engine should match or not greatly exceed the confocal scanner's etendue to generate the brightness levels at the sample plane.

In addition, a light guide such as a liquid light guide can have a relatively large etendue and will normally spread the light ray bundle out over the light guide's diameter and light guide's numerical aperture (NA). This increase in etendue can reduce the light levels at the sample plane by an order of magnitude or more. Therefore, the optics of coupling the light into the light guide and from the light guide into the confocal scanner should be designed in a manner to maintain the etendue and brightness levels. In one design, the light spot at the output aperture of the light engine is expanded to fill the input diameter of the light guide with a simultaneous reduction in the divergence angle. This design will then preserve the etendue of the light engine. A similar design approach should be used at the input side of the scanner. Additional attention is required to eliminate the light guide's tendency to spread the light rays in angle with every bend. This ray divergence can be reduced by restricting the number of bends and/or maximizing the bend radius to ensure relatively large turns.

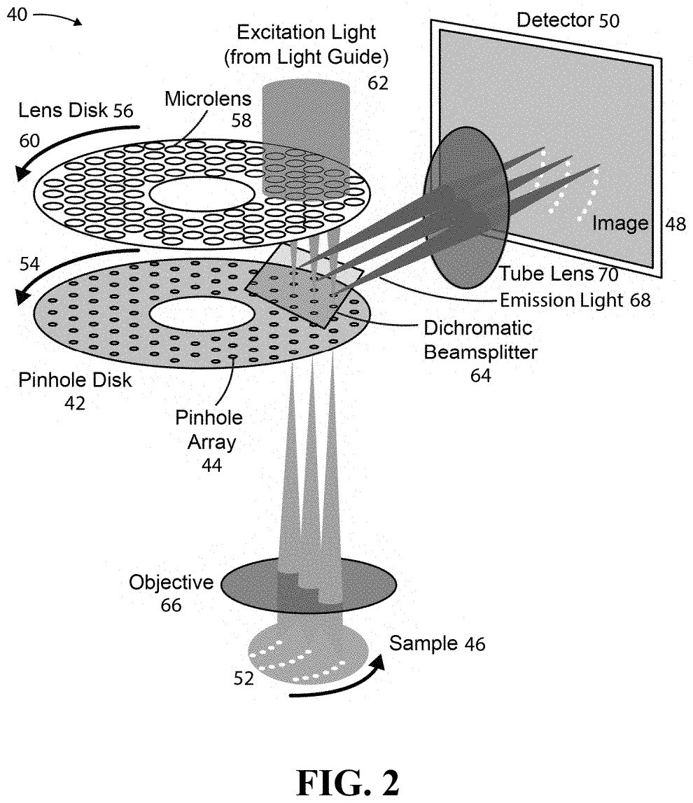

Confocal Optics. The confocal optics are used to achieve confocal illumination and detection from a sample. FIG. 2 shows aspects of a confocal microscopy system 40, such as the system of FIG. 1, emphasizing the confocal optics. These optics may be arranged in any suitable configuration, including folded optics configurations. In particular, the optics may be integral to the microscope or housed in a unit coupled to but separate from the microscope. Spinning disk confocal optics include a pinhole disk 42, such as a Nipkow disk, containing tens, hundreds, thousands, or tens of thousands of (typically equal-sized) pinholes 44. The disk and pinholes are located in a conjugate image plane. In other words, the pinhole disk, the sample 46, and the image 48 ultimately formed on the detector 50 are simultaneously in focus. Typically, a subset (e.g., ˜1000) of the pinholes is illuminated, and an objective projects their minified images 52 onto a sample to achieve multi-beam illumination. The pinhole disk is spun, as indicated by the arrow 54, causing the illuminated spots to move across the sample such the entire sample is eventually illuminated. In some embodiments, the entire sample can be illuminated with just a partial rotation of the disk, and this can be accomplished in as little as a millisecond.

The pictured embodiment, which can be termed a Yokogawa system, further includes a lens disk 56, matched to the pinhole disk, which contains a set of Fresnel or other microlenses 58 that focus the excitation light onto aligned pinholes in the pinhole disk. The lens disk is spun, as indicated by arrow 60, in tandem with the pinhole disk, maintaining their relative alignments. The use of microlenses in the excitation path enhances light relative to systems that lack microlens arrays. The result may be markedly improved image brightness. Rapid image acquisition may be achieved using pinholes arranged in sets of nested spirals that illuminate the specimen uniformly and generate a complete image after only a partial (e.g., each 30°) rotation of the disk.

In use, excitation light 62 generated by a light engine, and conveyed to the confocal optics by a light guide, is projected onto a portion of the lens disk. The excitation light is focused by the illuminated lenses in the lens disk onto corresponding pinholes in the pinhole disk, passing in the process through a dichromatic beamsplitter 64. Excitation light from the pinholes is focused onto discrete spots on the sample by an intervening objective lens 66. Fluorophores in the illuminated spots create florescence emission light 68. A portion of the emission generated by each spot passes back through the same pinhole as the excitation light that induced the emission, leading to preferential rejection of out-of-focus fluorescence signal. Specifically, out-of-focus emission is blocked because it is defocused and so (mostly) misses the pinhole (and adjacent pinholes). Unlike the excitation, the emission bypasses the microlens array and is directed toward and projected onto the detector (typically, an imaging detector) by the dichromatic beamsplitter disposed between the pinhole and lens disks. The beamsplitter passes excitation light, as mentioned above, while reflecting the spectrally distinct emission light. A tube lens 70 and/or other optics disposed between the beamsplitter and detector may help focus the emission light onto the detector. In some embodiments, excitation and emission filters may be positioned between the light source and the beamsplitter in the excitation optical path and between the beamsplitter and the detector in the emission optical path, respectively. Excitation filters generally “clean up” the excitation light, passing only wavelengths or wavelength regimes of interest. Emission filters similarly generally clean up the emission light, most importantly by blocking errant excitation light that might otherwise be mistaken for emission.

The spinning disk system can, in principle, capture up to several thousand frames per second, which is markedly superior to an LSCM. In reality, other limitations typically lead to reduced acquisition rates. One example is the need to collect an acceptably strong signal from a dim sample, which often places an upper bound of 10 frames/second on acquisition rates. Thus, the use of high quality light guides, such as those described here, can be very important for speeding up image acquisition.

Exemplary confocal optics may include, among others, the Yokogawa CSU-W1 and CSU-X1 confocal scanner units. These may be used with any suitable microscope or microscope platform. Exemplary microscopes may include, among others, the Nikon Eclipse Ti2 inverted research microscope. See U.S. Provisional Patent Application Ser. No. 63/388,979, filed Jul. 13, 2022, for more details (particularly Appendices C1 and C2 with respect to confocal optics and Appendix D with respect to microscopes and microscope platforms).

Detector. The detector is used to capture fluorescence emission light generated by the confocal optics and generate an image. Laser-scanning confocal microscopy typically employs a point detector, since the image is built up one point at a time. Examples include a photomultiplier tube (PMT) and a photodiode, among others. Spinning disk confocal microscopy typically employs an imaging detector. Examples include a charge-coupled device (CCD), an electron-multiplying charge coupled device (EMCCD), a complementary metal-oxide-semiconductor (CMOS) device, and a high quantum efficiency back-illuminated scientific complementary metal-oxide semiconductor (sCMOS) device, among others. Exemplary detectors may include, among others, the pco.edge 3.1 scientific CMOS camera. See U.S. Provisional Patent Application Ser. No. 63/388,979, filed Jul. 13, 2022, for more details (particularly Appendix E).

Examples, Components, and Alternatives

The following subsections, A to C, describe selected aspects of confocal microscopy systems with improved illumination. The examples in these subsections are intended for illustration and should not be interpreted as limiting the entire scope of the present disclosure. Each subsection may include one or more distinct examples, and/or contextual or related information, function, structure, and/or processes.

A. Exemplary Liquid Light Guide

This subsection describes aspects of an exemplary LLG. The LLG, as its name suggests, includes a liquid core. The LLG generally may have any suitable size (diameter and/or length), shape, and/or composition. Exemplary diameters may include 2 mm, 3 mm, 5 mm, 5.1 mm, and 7.6 mm, among others. Exemplary lengths may include 1.0 m, 1.2 m, 1.5 m, 1.8 m, 2.0 m, and 2.4 m, among others.

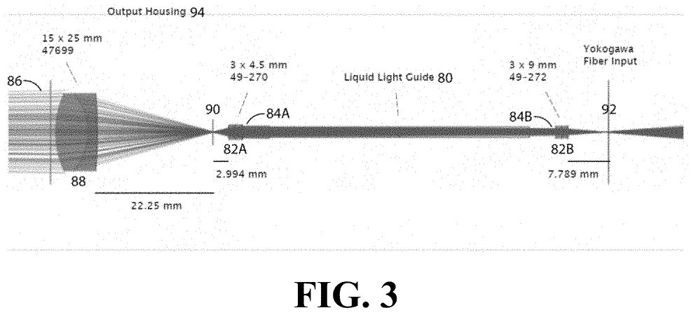

FIG. 3 shows an exemplary LLG 80 coupled (on the left) to the output of a light engine and (on the right) to the input of suitable confocal optics. The LLG itself may include input optics and output optics, such as lenses 82A and 82B positioned, respectively, at an upstream end 84A and a downstream end 84B of the LLG. Here, collimated light 86 from the light engine may be focused by a focusing lens 88 onto a front focal plane 90 of the input optics of the LLG. Consequently, light may preferentially be collimated within the LLG. Such collimated light exiting the LLG may preferentially be focused onto a back focal plane 92 of the output optics of the LLG. The confocal optics may be positioned to receive such light and, preferentially, recollimate it such that it is uniform and homogenized as it proceeds through the confocal optics. The figure further shows exemplary lens dimensions, focal lengths, and positions for a 2-mm LLG. In cases, the LLG and other components may be disposed within a housing 94 for support and protection.

B. Exemplary Reflecting Tube

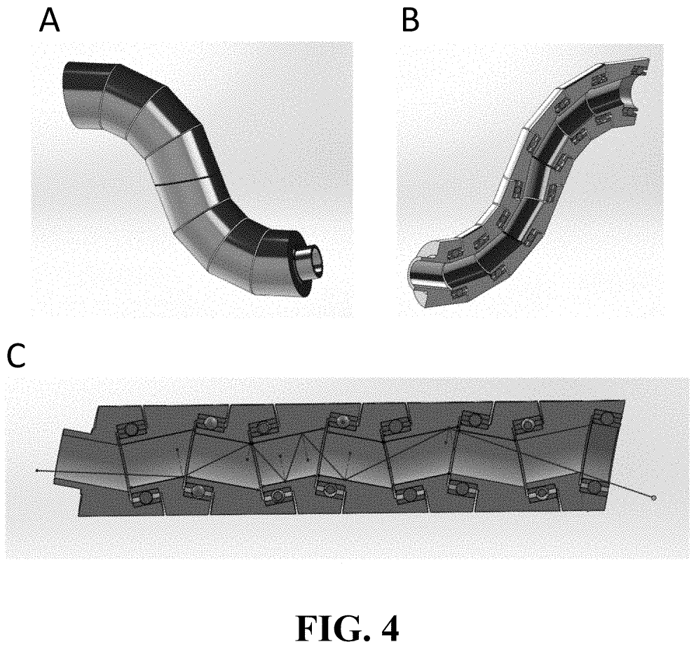

This subsection describes an exemplary reflecting mirror tube. The mirror tube, like the LLG, generally may have any suitable size, shape, and/or composition. The tube may be segmented, for flexibility, with sections joined by suitable connectors, such as ball bearings. FIG. 4 shows an exemplary reflecting mirror tube with machined and polished aluminum segments and standard ball-bearing connectors. Panel A shows an exterior view, Panel B shows a cross-sectional view, and Panel C shows an exemplary light trajectory through the tube.

C. Exemplary Embodiments

This section describes additional selected aspects of the present disclosure, presented without limitation as a series of paragraphs, some or all of which may be alphanumerically indexed for clarity and efficiency. Each of these paragraphs can be combined with one or more other paragraphs, and/or with disclosure from elsewhere in this application (including disclosure from the cross-referenced applications), in any suitable manner. Some of the paragraphs below expressly refer to and further limit other paragraphs, providing without limitation examples of some of the suitable combinations. limitation as a series of paragraphs.

A. A spinning-disk confocal microscopy (SDCM) system, comprising (a) a light engine including at least one light source, the light engine being configured to produce fluorescence excitation light; (b) confocal optics configured to direct the fluorescence excitation light onto a sample and to collect fluorescence emission light emitted by the sample, wherein the confocal optics simultaneously illuminate and collect light from at least two discrete positions in the sample separated by an unilluminated region; (c) a detector configured to capture fluorescence emission light from the sample to form an image of the sample; and (d) a light guide, other than a fiber optic, that transmits fluorescence excitation light output from the light engine to the confocal optics.

A1. The system of paragraph A, wherein the light guide is a flexible light guide.

A1A. The system of paragraph A1, wherein the light guide is a liquid light guide.

A1A1. The system of paragraph A1A, wherein a core diameter of the liquid light guide is greater than about 1 mm.

A1A1A. The system of paragraph A1A1, wherein the core diameter of the liquid light guide is 2 mm.

A1B. The system of paragraph A1, wherein the light guide is a reflecting mirror tube.

A1B1. The system of paragraph A1B, the reflecting mirror tube being segmented, wherein connections between the segments include ball bearings.

A1C. The system of paragraph A1, further comprising a shaker configured to shake the light guide to further homogenize the light.

A2. The system of paragraph A, further comprising converging lenses positioned immediately upstream and downstream of the light guide, wherein the upstream lens shapes the incoming light to match an acceptance angle of the light guide, and the downstream lens shapes the outgoing light for entry into the confocal optics.

A2A. The system of paragraph A2, wherein the diameter of the converging lenses is greater than a core diameter of the light guide.

A3. The systems of paragraph A, wherein the light engine includes at least two lasers.

A3B. The system of paragraph A3, wherein each laser emits light at a different wavelength or range of wavelengths.

A4. The system of paragraph A or A3, wherein the light engine includes a light pipe.

A5. The system of paragraph A or A3, wherein the light engine includes a light-emitting diode (LED).

A6. The system of paragraph A or A3, wherein the light engine includes both a light pipe and a light-emitting diode (LED).

A7. The system of paragraph A, wherein the light engine includes a number of separate light sources, the number being selected from the following group: two, three, four, five, six, seven, eight, and nine.

A8. The system of paragraph A, the light engine including at least three separate light sources, wherein two of the light sources produce light having the same spectral qualities, and wherein such light is combined to increase its intensity.

A9. The system of paragraph A, wherein the light engine emits light in at least two distinct wavelength regimes.

A9A. The system of paragraph A9, wherein the intensity of light in each of the at least two distinct wavelength regimes is independently adjustable.

A9B. The system of paragraph A9, wherein the intensity of light in one wavelength regime can be held constant while the intensity of light in the other wavelength regime is varied.

A10. The system of paragraph A, wherein the light from each light source is reflected by a mirror before being combined with light from another light source.

A10A, The system of paragraph A10, wherein the orientation of the mirror can be adjusted to align the light produced by the source with light produced by other sources.

A10B. The system of paragraph A10, wherein the orientation of the mirror can be adjusted to align the light produced by the source with an entrance to the light guide.

A11. The system of paragraph A, wherein light from each light source is combined along a same optical path.

A11A The system of paragraph A11, wherein the combined light is directed onto the light guide.

A12. The system of paragraph A, wherein the light sources are mounted on a common platform.

A12A The system of paragraph A12, wherein the light sources are positioned within recesses in the platform.

A13. The system of paragraph A, wherein the confocal optics include a Nipkow pinhole disk.

A13A. The system of paragraph A13, wherein an intensity of excitation light incident on the pinhole disk is substantially uniform over at least a portion of the pinhole disk illuminated by the excitation light.

A13B. The system of paragraph A13 or A13A, wherein the confocal optics further include a lens disk.

A14. The system of paragraph A, wherein the confocal optics are Yokogawa optics.

A15. The system of paragraph A, wherein the detector includes an imaging detector.

A16. The system of paragraph A, wherein the imaging detector is a charge-coupled device (CCD).

A17. The system of paragraph A, wherein the imaging detector is a complementary metal-oxide-semiconductor (CMOS) device.

A18. The system of paragraph A, further comprising a controller that controls the wavelength(s) and/or duration of light emitted by the light engine.

B. A method of performing confocal microscopy, comprising (a) providing a sample, and (b) imaging the sample using the system of one of paragraphs A-A18.

C. A reflecting mirror tube light guide as described herein (including the Appendices).

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

What is claimed:

1. A spinning-disk confocal microscopy system, comprising:
(a) a light engine including at least one light source, the light engine being configured to produce fluorescence excitation light;
(b) confocal optics configured to direct the fluorescence excitation light onto a sample and to collect fluorescence emission light emitted by the sample, wherein the confocal optics simultaneously illuminate and collect light from at least two discrete positions in the sample separated by an unilluminated region;
(c) a detector configured to capture fluorescence emission light from the sample to form an image of the sample; and
(d) a light guide, other than a fiber optic, that transmits fluorescence excitation light output from the light engine to the confocal optics.

2. The system of claim 1, wherein the light guide is a flexible light guide.

3. The system of claim 2, wherein the light guide is a liquid light guide.

4. The system of claim 3, wherein a core diameter of the liquid light guide is greater than 1 mm.

5. The system of claim 4, wherein the core diameter of the liquid light guide is 2 mm.

6. The system of claim 2, wherein the light guide is a reflecting mirror tube.

7. The system of claim 6, the reflecting mirror tube being segmented, wherein connections between the segments include ball bearings.

8. The system of claim 2, further comprising a shaker configured to shake the light guide to further homogenize the light.

9. The system of claim 1, further comprising converging lenses positioned immediately upstream and downstream of the light guide, wherein the upstream lens shapes the incoming light to match an acceptance angle of the light guide, and the downstream lens shapes the outgoing light for entry into the confocal optics.

10. The system of claim 9, wherein the diameter of the converging lenses is greater than a core diameter of the light guide.

11. The systems of claim 1, wherein the light engine includes at least two lasers.

12. The system of claim 11, wherein each laser emits light at a different wavelength or range of wavelengths.

13. The system of claim 11, wherein the intensity of light from each of the at least two lasers is independently adjustable.

14. The system of claim 1, the light engine having at least two light sources, wherein light from each light source is combined along a same optical path.

15. The system of claim 1, wherein the confocal optics include a Nipkow pinhole disk.

16. The system of claim 15, wherein the confocal optics further include a lens disk.

17. The system of claim 15, wherein an intensity of excitation light incident on the pinhole disk is substantially uniform over at least a portion of the pinhole disk illuminated by the ex.

18. The system of claim 1, wherein the confocal optics are Yokogawa optics.

19. The system of claim 1, wherein the detector includes an imaging detector.

20. A method of performing confocal microscopy, comprising (a) providing a sample, and (b) imaging the sample using the system of claim 1.
